(19) United States
(12) Patent Application Publication
(10) Pub. No.: US 2014/0215450 A1
(43) Pub. Date: Jul. 31, 2014

(54) SYSTEM AND METHOD FOR UPDATING SOFTWARE

(71) Applicant: TRANE INTERNATIONAL INC., Piscataway, NJ (US)

(72) Inventors: Peter Reed SALISBURY, White Bear Lake, MN (US); James Frederick JOHNSON, Lake Elmo, MN (US)

(73) Assignee: TRANE INTERNATIONAL INC., Piscataway, NJ (US)

(21) Appl. No.: 14/168,620

(22) Filed: Jan. 30, 2014

Related U.S. Application Data
(60) Provisional application No. 61/759,058, filed on Jan. 31, 2013.

(51) Int. Cl. G06F 9/445

(52) U.S. Cl. CPC G06F 8/65
USPC 717/170; 717/172; 717/173

(57) ABSTRACT

A system and a method for automatically electronically pushing software updates to one or more mobile computers to ensure that the one or more mobile computers can have the most recent version of the software needed, and electronically pushing information to be displayed on a display of the mobile computer to ensure that the one or more mobile computers notify a user of an existence of the information.

### FIELD

The embodiments disclosed herein relate to systems and methods for updating software installed on a mobile computer. In particular, the embodiments disclosed herein relate to systems and methods for automatically offering to update and/or automatically updating software installed on a mobile computer. The embodiments disclosed herein also relate to automatically providing information to be displayed on the mobile computer, wherein the information includes information about the software update.

### BACKGROUND

Field technicians use mobile computers having software (including electronic documentation) necessary for performing field service to refrigeration and/or climate control systems. Software is used herein to include computer stored electronic data, information, documentation, computer-executable programs, etc. An example of the software when executed on the mobile computer makes the mobile computer a specific device for testing and/or operating a control of a refrigerant system or a heating, ventilation, and air conditioning (HVAC) system. Another example of the software is electronic documentation regarding an operation of a refrigerant system or a HVAC system. Generally, each field technician is individually responsible for updating the software installed on the mobile computer assigned to the field technician. In order to update the software on the mobile computer assigned to the field technician, the field technician must “pull” the update from another source, such as a server. The term “pull” means that a user of the mobile computer must access a remote server, manually navigate to multiple download pages, find one or more of the software and/or software updates desired for installation onto the mobile computer, manually navigate to more download pages, and then initiate the request to download and then install the one or more of the software and/or software updates. When the software is an electronic literature related to the field technician's job, the field technician must first become aware of the fact that an updated electronic version of the electronic literature exists, and then the electronic literature must be found, downloaded, and installed on the mobile computer by the field technician. Generally, relying on each field technician to be individually responsible for maintaining the most recent versions of the software installed on the mobile computer makes it difficult to achieve uniformity of software (i.e., software versions and electronic literature) installed on every mobile computer used by the field technicians.

### SUMMARY

Embodiments of a system and a method disclosed herein are directed towards addressing the following problems of managing uniformity of software and/or software updates installed on every mobile computer used by the field technicians.

A problem with the prior art methodology that relies on each field technician to “pull” the software is that the prior art methodology requires each field technician to take one or more proactive actions (e.g., multiple complex actions that include searching and/or manually navigating to multiple download pages). Embodiments of the system and the method disclosed herein eliminate the need for the “pull” actions (e.g., the multiple complex actions).

Another problem with the prior art methodology that relies on each field technician to “pull” the software is that the prior art methodology makes it inherently difficult to maintain uniformity of a software version (e.g., software updates) installed on the plurality of mobile computers. Non-uniformity of software versions is known in the field as “fragmentation” (i.e., different devices having different versions of software). That is, the prior art methodology makes it difficult to ensure that every field technician always has a mobile computer having the most recent version of the software they need to do their jobs so that going to a remote job site without the proper software tools can be avoided. Embodiments of systems and methods disclosed herein ensure that every mobile computer can have the most recent version of the software needed by the field technicians to do their jobs.

Yet another problem with the prior art methodology that relies on each field technician to “pull” the software is that the prior art methodology requires that the field technician must first become aware of an existence of new or the most recent electronic literature related to the performance of their jobs, and then for each field technician to find the new or the most recent electronic literature, “pull” the electronic literature to install it to the mobile computer. Accordingly, the prior art methodology makes it difficult to ensure that every field technician always has a mobile computer having the most recent electronic literature they need to do their jobs so that going to a remote job site without the proper electronic literature can be avoided. Embodiments of systems and methods disclosed herein ensure that every mobile computer can notify a user of an existence of new or the most recent electronic literature so that the mobile computer can have the most recent electronic literature needed by the field technicians to do their jobs.

Even yet another problem with the prior art methodology that relies on each field technician to “pull” the software is that the prior art methodology requires multiple steps when setting up a new mobile computer by installing all of the necessary software and electronic literature needed by a field technician. Such process can take an enormous amount of time and many complex steps by a user. Embodiments of systems and methods disclosed herein can ensure that a new mobile computer can be automatically set up and then be installed with all of the most recent versions of software and electronic literature needed by a field technician, without requiring enormous amount of time and many complex steps by the user.

A field technician using a mobile computer for servicing refrigeration and/or HVAC systems may need multiple computer programs and/or literature in order to perform a service job. It is difficult for the field technician who services refrigeration and/or HVAC systems to know about every single update for the multiple computer programs and/or literature. Accordingly, relying on each field technician to be individually responsible for maintaining the most recent versions of software installed on the mobile computer makes it very difficult to achieve uniformity of software (e.g., software versions and/or electronic literature) installed on every mobile computer used by the field technicians. Further, when there are multiple field technicians, each having his/her own mobile computer, and the computer program and/or literature updates are provided by multiple servers, there can be an inefficiency of network usage (e.g., bandwidth usage, server load, etc.) by the field technicians because the field technicians generally are not aware of what the other field technicians are updating. Accordingly, there can be a situation where a particular server for providing a particular software can be overloaded with multiple pull (e.g., download) requests which overloads the server and a region of the network that the overloaded server is connected to. Thus, the overall download time for the multiple mobile computers is increased, and the network usage becomes inefficient. An embodiment of a system disclosed herein includes a control server that controls a schedule of downloads to each of the mobile computers to achieve improved network usage. An embodiment of a system includes a server that connects to other servers and downloads software, and then provides that downloaded software to the multiple mobile computers, so that there is no need for each of the mobile computers to connect to the other servers in order to receive the software. An embodiment of a system includes a server that is the control server and the server that downloads software. An embodiment of a system includes the control server connected to the server that downloads software, and then provides that downloaded software to the multiple mobile computers.

### BRIEF DESCRIPTION OF THE DRAWINGS

FIG. 1 shows a schematic diagram of an embodiment of a computer network system for updating software installed on a mobile computer.

FIG. 2 shows an example of a user interface of a computer-implemented embodiment of a method for updating software installed on a mobile computer.

FIG. 3 shows an example of a user interface of a computer-implemented embodiment of a method for updating software installed on a mobile computer.

FIG. 4 shows a flowchart according to an embodiment of a method for updating software installed on a mobile computer.

FIG. 5 shows another example of a user interface of a computer-implemented embodiment of a method for updating software installed on a mobile computer.

FIG. 6 shows another example of a user interface of a computer-implemented embodiment of a method for updating software installed on a mobile computer.

### DETAILED DESCRIPTION

Systems and methods disclosed herein are directed towards automatically and electronically pushing software updates to one or more mobile computers to ensure that the one or more mobile computers can have the most recent version of the software needed, and/or electronically pushing information to be displayed on a display of the mobile computer to ensure that the one or more mobile computers notify a user of an existence of the information.

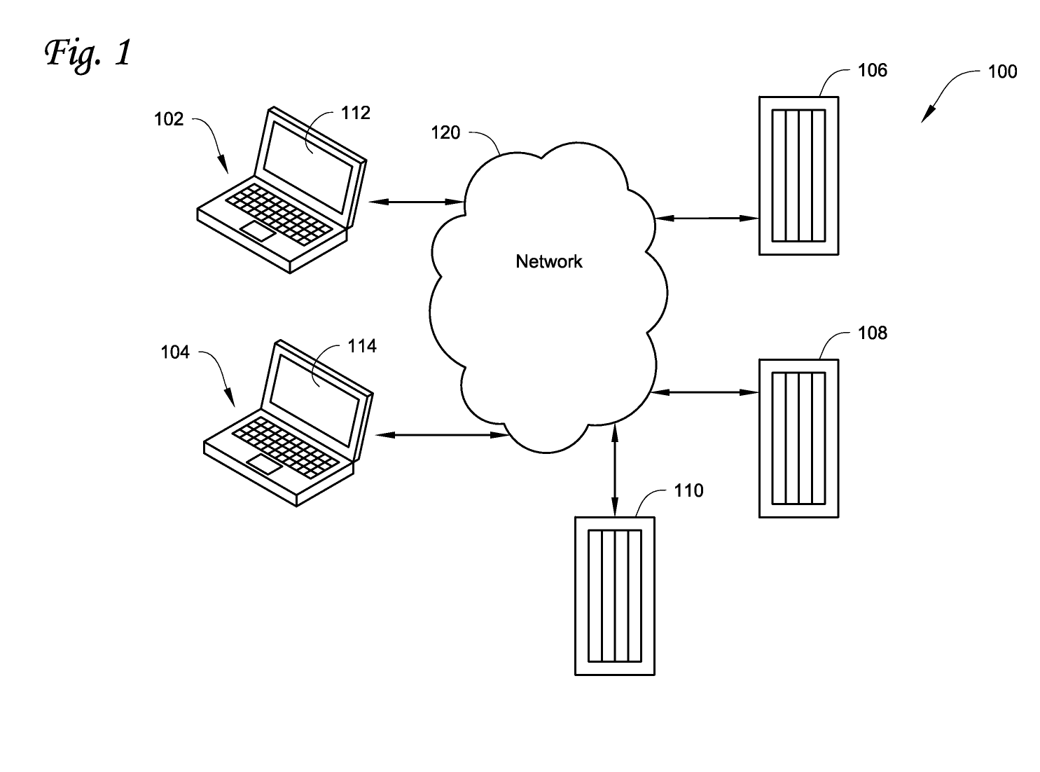

FIG. 1 shows an embodiment of a system 100 for electronically pushing software updates to one or more mobile computers 102, 104 from one or more servers 106, 108, 110 to ensure that the mobile computers 102, 104 can have the most recent version of the software and/or other data needed. The system 100 includes at least one server 106, 108, 110 connected to at least one mobile computer 102, 104 via a network 120 (e.g., computer network, intranet, internet, wireless network, etc.). Examples of the mobile computer 102, 104 include, but are not necessarily limited by, a notebook computer, a portable computer, a mobile smart device, a tablet, a smart phone, etc. At least one of the servers 106, 108, 110 can be for managing uniformity of software and/or software updates for being downloaded to the mobile computers 102, 104 used by field technicians. For example, the server 106 can be configured to push software updates and/or data associated with software to one or more of the mobile computers 102, 104.

The term “push” (or “pushing”) used herein means a method of delivering (e.g., providing, sending, transmitting, etc.) computer-readable electronic data (e.g., software) from a software providing computer (e.g., the server 106 which stores into its non-transitory memory electronic data and/or software for transmitting the electronic data and/or software) to a client computer (e.g., one or more of the mobile computers 102, 104, each executing a client program for receiving the transmitted electronic data and/or software). For example, the server 106 can be configured to store a software in a server memory and the server 106 pushes the software to one or more mobile computers 102, 104 running a client program, wherein the client program receives (e.g., downloads) the software pushed from the server 106 and then configures the mobile computer 102, 104 with the downloaded software (e.g., installs the software, stores the software in a memory, executes the software and performs other actions according to the computer instructions being executed by the processor, etc.). The pushing and downloading steps can be performed automatically without requiring a user to specifically and manually interface with the server 106 to pull the software from the server 106 manually for installing the software into each of the mobile computers 102, 104.

In an embodiment of the system 100, a single server 106 controls the pushing of the software to each of the mobile computers 102, 104. Accordingly, the server 106 can control and manage the amount of network 120 traffic that is used by the updating process. That is, the server 106 can manage the updating of the mobile computers 102, 104 with efficient management of the network 120 bandwidth usage. Further, the server 106 can control the access to the other servers via controlling access to the servers 106, 108, 110 via a secured authentication process, thus eliminating the need for each of the mobile computers 102, 104 to go through multiple authentication process to access each of the servers 106, 108, 110. This can lead to savings of time by the user(s). Further, this embodiment can also lead to savings of time over prior methods that can slow download speeds due to network delay (or server overload) when individual users connect separately to the servers 106, 108, 110 and attempt to pull the software from the servers 106, 108, 110, without regard for the status of network connections and/or server load.

The term “push” can also apply to pushing data (e.g., information, patch notes, etc.) associated with software (e.g., new software, software update, etc.) to be downloaded. For example, when there are one or more servers 106, 108, 110, each of the servers 106, 108, 110 may be configured with its own memory, wherein each of the server memory stores a different software update. One or more of the mobile computers 102, 104 may need one or more software updates from the servers 106, 108, 110. In this case, at least one of the servers 106 is configured to push data associated with the software updates to the mobile computer 102, 104. The mobile computer 102, 104 running a client program receives the data associated with the software updates. The data associated with the software updates includes information regarding each of the software updates, such as a server identification data of a network address of the server 106, 108, 110 which has the software update, so that the client program running on the mobile device 102, 104 can connect to the server 106, 108, 110 at the network address, download the software update from the server 106, 108, 110 for installing the software update to the mobile computer 102, 104. Thus, the pushing, requesting, and downloading steps can be performed automatically for each of the mobile computers 102, 104 without requiring a user to specifically and manually interface with each of the servers 106, 108, 110 to pull the software updates from them.

Further, the system 100 can include one or more servers 106, 108, 110 which can electronically push information to be displayed on a display 112, 114 of each of the mobile computers 102, 104 to ensure that each of the mobile computers 102, 104 can notify a user of an existence of the pushed information. For example, the information to be displayed includes “news,” or any information that one of the servers 106 provides to a mobile computer 102, 104 so that a field technician can be informed of that information. The information is displayed via an information screen on the display 112, 114 of the mobile computer 102, 104. The information screen includes a “news page” for displaying the news received from one of the servers, e.g., 106. The information screen includes a “news page” for displaying the news received. The news is automatically “pushed” by the server 106 to the mobile computers 102, 104 so that the user of the mobile computers 102, 104 does not need to take an action for downloading the news from a server 106 with the mobile computers 102, 104. The news can be displayed on the displays 112, 114 of the mobile computers 102, 104 via the information screen. The information screen is displayed until the user manually closes the information screen, which would ensure that the user has, at least, seen the news or is aware that the news is available. Once the user has closed the information screen (e.g., news page), the client program running on the mobile computer 102, 104 will not necessarily automatically display the information screen again until new or updated information is available (e.g., released and pushed by the server 106). Accordingly, the amount and subject of information pushed by one or more servers to one or more of the mobile computers 102, 104 can be controlled with a single server e.g., 106 because the information screen displayed on the mobile computers 102, 104 can be generated only by a single source (e.g., the server 106).

Thus, the system 100 eliminates the need for a user to “pull” each and every software update from each of the server(s) 106, 108, 110 separately. The system 100 can ensure that every mobile computer 102, 104 can have the most recent version of the software needed by the field technicians to do their jobs. The system 100 can ensure that every mobile computer 102, 104 can notify a user that new or the most recent electronic literature is available so that the mobile computer 102, 104 can retrieve the most recent electronic literature needed by the field technicians to do their jobs. The system 100 can ensure that a new mobile computer can be connected to the network 120 and be automatically set up and be installed with all of the most recent versions of software and electronic literature needed by a field technician, without requiring enormous amount of time and many complex steps by a user (or IT personnel).

In an embodiment of the system 100, one of the servers 106 connected to the network 120 is a control server that controls a schedule of downloads to each of the mobile computers 102, 104 to achieve improved network usage. An embodiment of the system 100 includes a server 106 that connects to other servers 108, 110 and downloads software to store the software on the server 106, and then pushes that downloaded software to the multiple mobile computers 102, 104, so that there is no need for each of the mobile computers 102, 104 to connect to the other servers 108, 110 in order to have the software. An embodiment of the system 100 includes a server 106 that functions as the control server and the server that downloads software. An embodiment of the system 100 can include a control server 106 and another server 108 that downloads software to store the software on the server 108, and then pushes that downloaded software to the multiple mobile computers 102, 104, so that there is no need for each of the mobile computers 102, 104 to connect to the other servers 110 in order to have the software. Accordingly, the system 100 can avoid a situation where a particular server for providing a particular software is overloaded with multiple pull (e.g., download) requests from mobile computers 102, 104, and thus, the overall download time of the software for the multiple mobile computers 102, 104 is decreased, and the network usage for downloading software by the mobile computers 102, 104 becomes orderly (e.g., controlled) and/or more efficient.

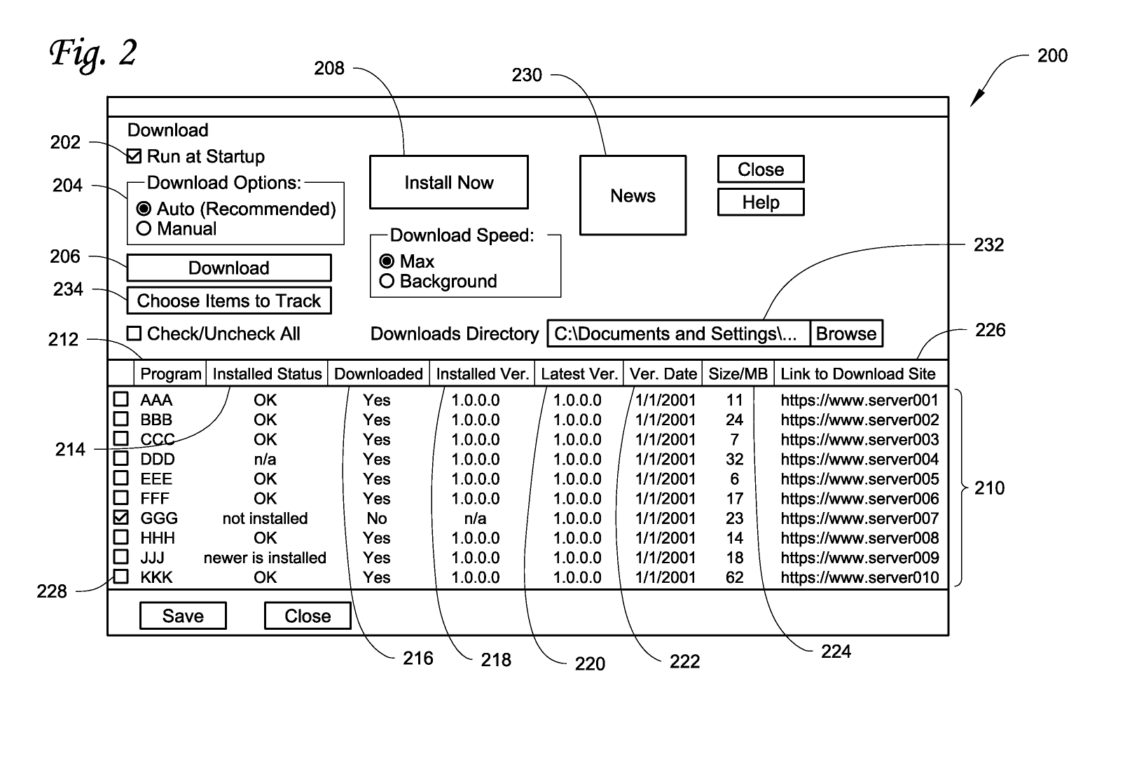

FIG. 2 shows an example of a user interface 200 of a computer-implemented embodiment of a method for updating software installed on a mobile computer (e.g., the mobile computer 102 shown in FIG. 1). The user interface 200 is displayed on a display (e.g., the display 112 shown in FIG. 1). The user interface 200 can provide a single interface for field technicians to maintain current versions of software and literature; enable a customized range of user experience from automated installation of software or manual selection of software for installation of software; support multiple levels of access for multiple users; and support connecting to a server via an intranet network and/or a remote server.

A client program for displaying the user interface 200 is executed by the mobile computer upon turning on the mobile computer when the setting option “Run at Startup” 202 is selected (or had been selected previously). For example, at the first “boot-up” of the day, the client program is executed by the mobile computer and the user interface 200 is displayed on the display of the mobile computer. The number of times the client program is executed in one day may be configured. For example, the client program may be set so that it is executed by the mobile computer only once per day, so that the user interface 200 is displayed only once per day. The user interface 200 displays a setting option 204 for automatic or manual downloading of software updates. If “Auto” download setting is selected, all of the software updates are automatically downloaded to the mobile computer upon the execution of the client program. It will be appreciated and understood that the downloaded software updates can be installed to the mobile computer as desired by the user of the mobile computer. For example, when the “Run at Startup:” 202 is selected and the mobile computer is booted up for the first time in the day, the client program is executed and all of the available software updates are downloaded automatically without a need of a user interacting with the mobile computer to perform/install the software updates. If the setting option 204 is selected to “Manual,” then a user can click on the “Download” button 206 to initiate the downloading of the available software updates. The user can click the “Install Now” button 208 to initiate the installation of the manually downloaded software updates to the mobile computer. The “Install Now” button 208 can be deactivated when the setting option 204 is selected to “Auto” so that the installation is performed automatically. Alternatively, the “Auto” setting option 204 can automatically download the software updates but still require the user to interact with the “Install Now” button 208 to install the automatically downloaded software updates. It is also possible that the “Install Now” button 208 can install both the manually downloaded and automatically downloaded software updates.

The user interface 200 includes a software window 210 displaying a sortable list of software (and/or updates) available for downloading and/or installation to the mobile computer. The software window 210 shows the sortable list of software information, such as, for example, name of a program 212, installation status 214, download status of the software 216, installed version of the software 218, most current version of the software available 220, release date of the latest version 222, size of the software 224, and server identification information 226 (e.g., web address of the server).

An embodiment of the user interface 200 allows, when in “Manual” mode, a user to select which software to download (e.g., by selecting one or more software from a list of software information displayed in a software window 210 and then clicking the “Download” button 206) and/or which downloaded software to be installed (e.g., by selecting one or more downloaded software from a list of software information displayed in a software window 210 and then clicking the “Install Now” button 208).

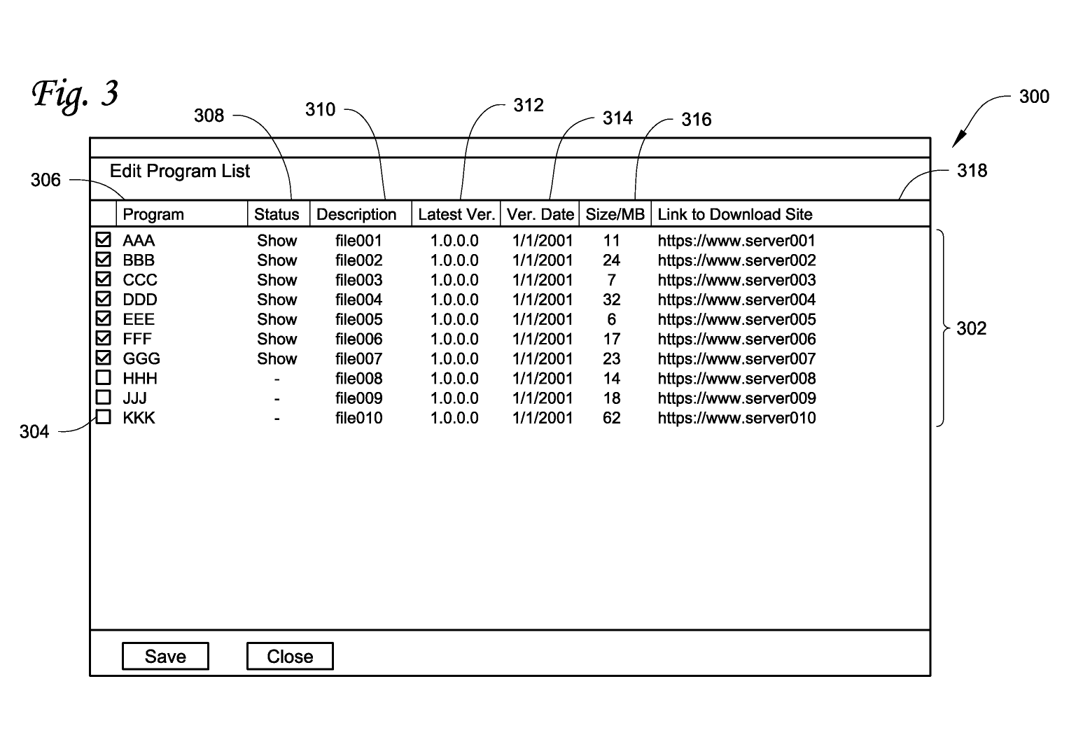

The information displayed in the software window 210 is pushed from a server to the mobile computer, and the client program provides the received information in this manner. Clicking on any of the server identification information 226 executes a program on the mobile computer for connecting to the server at that web address. The software window 210 also includes a check box 228 for each of the software listed in the software window 210 so that a user can select whether the selected software is to be listed in a “watch list” for available updates (see FIG. 3).

The user interface 200 includes a “News” button 230, which, when clicked, can display “news” information that is pushed from a server. The user interface 200 includes a download directory field 232 which identifies a directory location for the downloaded software in a memory of the mobile computer.

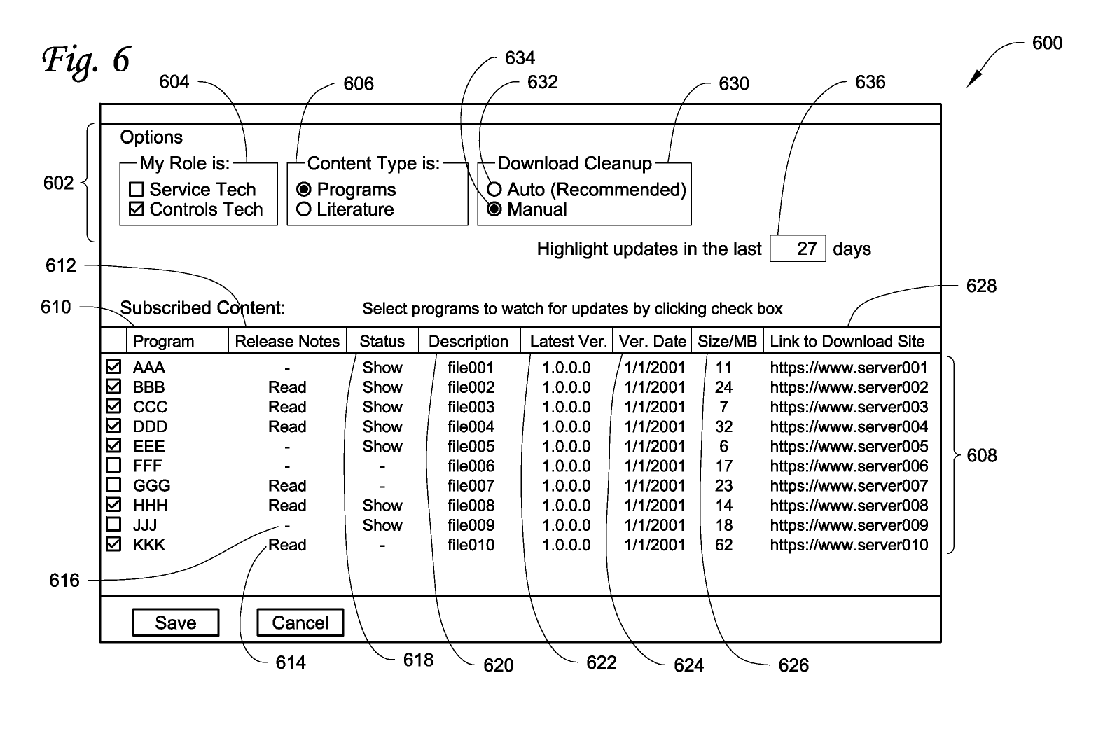

The user interface 200 includes a “Choose Items to Track” button 234, when clicked, can display an Options window, examples of which are shown in FIG. 6.

FIG. 3 shows an example of a user interface 300 of a computer-implemented embodiment of a method for updating software installed on a mobile computer (e.g., the mobile computer 102 shown in FIG. 1). The user interface 300 is a “watch list” of software updates selected 228 from the user interface 200 shown in FIG. 2. The user interface 300 includes a software list window 302 which shows a list of software information, such as, for example, watch selection box 304, name of a program 306, whether to show status 308, description information of the software 310, most current version of the software available 312, release date of the latest version 314, size of the software 316, and server identification information 318 (e.g., web address of the server). Clicking on any of the server identification information 318 executes a program on the mobile computer for connecting to the server at that web address.

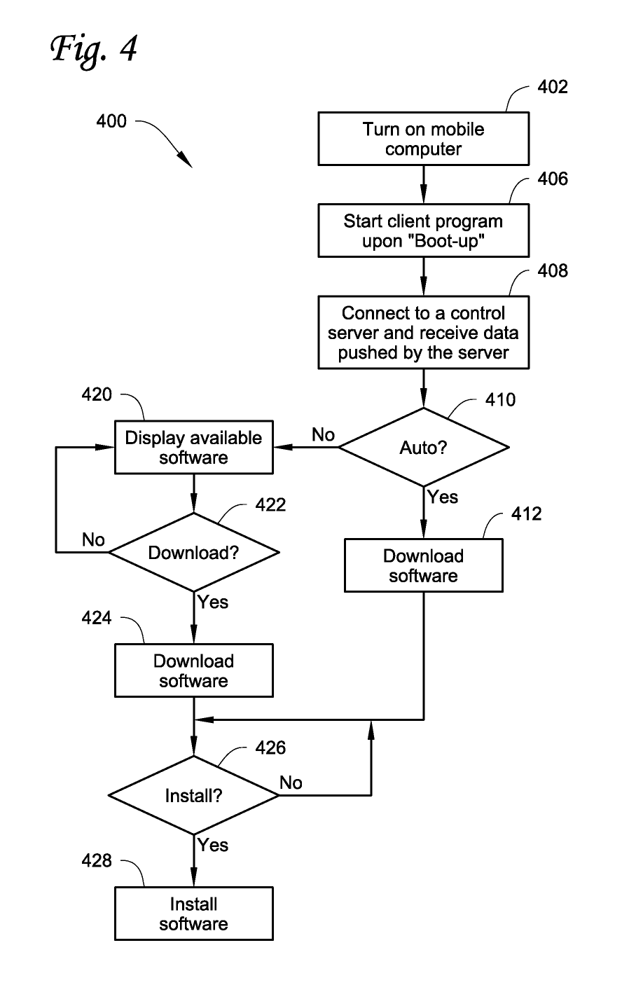

FIG. 4 shows a flowchart 400 of an embodiment of a method, wherein the method includes the steps of a mobile computer being turned on 402, executing 406 a client program upon “boot-up” of the mobile device, the mobile computer connecting 408 to a control server to receive information (e.g., data about software updates available and news) pushed by the control server. Then, the method includes a step of determining whether the client program is set for automatic download and installation of software 410. If the client program is set for automatic download of software, then the client program initiates the download of the software 412. After the download is completed, the method can wait for the user (which is represented by the “No” arrow in step 426) to select to install the downloaded software 426 by initiating a control with the client program (e.g., interacting with an icon for initiating the installation of the downloaded software, which is represented by the “Yes” arrow in step 426). It will be appreciated and understood that when the user provides a command to initiate the installation of the downloaded software, the client program detects that command and initiates the installation of the downloaded software 428 to the mobile computer. It is to be noted that in the automatic setting, the client program displays available software on a display of the mobile device, as shown in examples of the user interfaces 200 and 300 in FIGS. 2 and 3. If the client program is not set for automatic download and installation of software, i.e., the client program is set for manual control, then the client program displays available software 420 on a display of the mobile device, as shown in examples of the user interfaces 200 and 300 in FIGS. 2 and 3. The method includes a waiting step for a user to select one or more software for downloading and providing a command to initiate the download of the selected software 422. Upon that command, the client program initiates the downloading of the selected software 424. The method includes a waiting step for a user to select to install the downloaded software 426. When the user provides a command to initiate the installation of the downloaded software, the client program initiates the installation of the downloaded software 428.

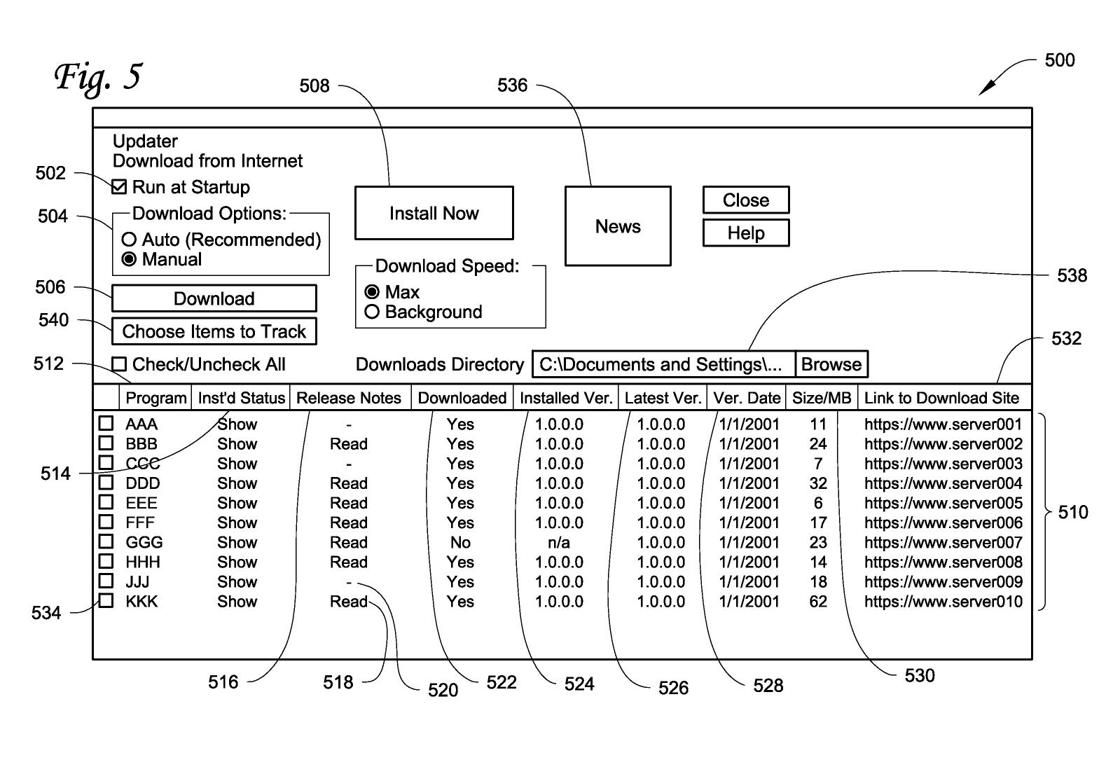

FIG. 5 shows another example of a user interface 500 of a computer-implemented embodiment of a method for updating software installed on a mobile computer (e.g., the mobile computer 102 shown in FIG. 1). The user interface 500 is displayed on a display (e.g., the display 112 shown in FIG. 1). The user interface 500 can provide a single interface for field technicians to maintain current versions of software and literature; enable a customized range of user experience from automated installation of software or manual selection of software for installation of software; support multiple levels of access for multiple users; and support connecting to a server via an intranet network and/or a remote server.

A client program for displaying the user interface 500 is executed by the mobile computer upon turning on the mobile computer when the setting option “Run at Startup” 502 is selected (or had been selected previously). For example, at the first “boot-up” of the day, the client program is executed by the mobile computer and the user interface 500 is displayed on the display of the mobile computer. The number of times the client program is executed in one day may be configured. For example, the client program may be set so that it is executed by the mobile computer only once per day, so that the user interface 500 is displayed only once per day. The user interface 500 displays a setting option 504 for automatic or manual downloading of software updates. If “Auto” download setting is selected, all of the software updates are automatically downloaded to the mobile computer upon the execution of the client program. It will be appreciated and understood that the automatically downloaded software updates can be installed to the mobile computer as desired by the user of the mobile computer. For example, when the “Run at Startup:” 502 is selected and the mobile computer is booted up for the first time in the day, the client program is executed and all of the available software updates are downloaded automatically without a need of a user interacting with the mobile computer to perform/install the software updates. If the setting option 504 is selected to “Manual.” then a user can click on the “Download” button 506 to initiate the downloading of the available software updates. The user can click the “Install Now” button 508 to initiate the installation of the manually downloaded software updates to the mobile computer. The “Install Now” button 508 can be deactivated when the setting option 504 is selected to “Auto” so that the installation is performed automatically. Alternatively, the “Auto” setting option 504 can automatically download the software updates but still require the user to interact with the “Install Now” button 508 to install the automatically downloaded software updates. It is also possible that the “Install Now” button 508 can install both the manually downloaded and automatically downloaded software updates.

The user interface 500 includes a software window 510 displaying a list of software (and/or updates) available for downloading and/or installation to the mobile computer. The software window 510 shows a sortable list of software information, such as, for example, name of a program 512, installation status 514, release notes 516 available for the software (wherein an interactive indicator such as “READ” indicator 518 is displayed so that when the user interacts with the indicator (e.g., clicking the READ indicator 518) the information data is downloaded and displayed on the display screen, wherein when there is no release note associated with a respective software the interactive indicator is not displayed 520), download status of the software 522, installed version of the software 524, most current version of the software available 526, release date of the latest version 528, size of the software 530, and server identification information 532 (e.g., web address of the server).

An embodiment of the user interface 500 allows, when in “Manual” mode, a user to select which software to download (e.g., by selecting one or more software from a list of software information displayed in a software window 510 and then clicking the “Download” button 506) and/or which downloaded software to be installed (e.g., by selecting one or more downloaded software from a list of software information displayed in a software window 510 and then clicking the “Install Now” button 508).

The information displayed in the software window 510 is pushed from a server to the mobile computer, and the client program provides the received information in this manner. Clicking on any of the server identification information 526 executes a program on the mobile computer for connecting to the server at that web address. The software window 510 also includes a check box 534 for each of the software listed in the software window 510 so that a user can select whether the selected software is to be listed in a “watch list” for available updates (see FIG. 3).

The user interface 500 includes a “News” button 536, which, when clicked, can display “news” information that is pushed from a server. The user interface 500 includes a download directory field 538 which identifies a directory location for the downloaded software in a memory of the mobile computer.

The user interface 500 includes a “Choose Items to Track” button 540, when clicked, can display an Options window, examples of which are shown in FIG. 6.

FIG. 6 shows an example of a user interface 600 of a computer-implemented embodiment of a method for updating software installed on a mobile computer (e.g., the mobile computer 102 shown in FIG. 1). The user interface 600 is a filterable list of software updates from the user interface 500 shown in FIG. 5.

The user interface 600 includes displaying an options portion 602 for selecting available filters, such as, for example, role of the user 604, and type of data 606 for displaying the filtered list of software in the software list window 608. The role of the user 604 selected can determine which software are available for download and installation to the mobile device. For example, a Service Tech might have different software available (or authorized by the server) as compared to a Controller Tech.

The software list window 608 which shows a sortable filtered list of available software and/or information are displayed with information, such as, for example, name of a program 610, release notes 612 available for the software (wherein an interactive indicator such as “READ” indicator 614 is displayed so that when the user interacts with the indicator (e.g., clicking the READ indicator 614) the information data is downloaded and displayed on the display screen, wherein when there is no release note associated with a respective software the interactive indicator is not displayed 616), download status of the software 618, description of the software/data 620, most current version of the software available 622, release date of the latest version 624, size of the software 626, and server identification information 628 (e.g., web address of the server).

The user interface 600 includes displaying other options, such as, Download Cleanup 630 selection option. When the “Auto” 632 cleanup option is selected, the client software automatically deletes the downloaded files based on predetermined criteria. As an example, the predetermined criteria can be how old the downloaded file is, by version number, or be based on how many different versions of the same software type are located in the memory of the mobile computer (e.g., a selected download folder in the hard drive). When the “Manual” 634 cleanup option is selected, the client software running on the mobile computer does not automatically delete the downloaded files.

The user interface 600 can include another option for easier view of the software list shown in the software list window 608. For example, the “Highlight updates in the last ______ days” 636 option allows the user to enter a number so that the software updates listed in the software list window 608 are highlighted (e.g., colored differently to stand out or indicated differently from the rest of the software listed in the list window 608). For example, the software meeting the criteria might be displayed in red color, while the rest of the software listed are displayed in black color in the list window 608. This can aid in identifying and/or filtering of the software list based on the user's preference.

With regard to the foregoing description, it is to be understood that changes may be made in detail without departing from the scope of the present invention. It is intended that the specification and depicted embodiment to be considered exemplary only, with a true scope and spirit of the invention being indicated by the broad meaning of the claims.

What is claimed is:

1. A computer network system, comprising:
a network;
a server connected to the network; and
one or more mobile computers connected to the network,
wherein the server is configured to schedule when to push electronic data to one or more of the mobile computers, and based on the schedule, push electronic data to one or more of the mobile computers, and
one or more of the mobile computers includes a client program stored in a non-transitory memory that receives the electronic data pushed from the server, stores the electronic data to the non-transitory memory of one or more of the mobile computers, and displays the electronic data on a display of one or more of the mobile computers.

2. The computer network system according to claim 1, wherein the client program of one or more of the mobile computers executes the electronic data to install or update a software to the non-transitory memory of the one or more of the mobile computers.

3. A computer network system, comprising:
a network;
a first server connected to the network;
a second server connected to the network;
one or more mobile computers connected to the network,
wherein the first server controls pushing of electronic data from the second server to one or more of the mobile computers via the network, and
one or more of the mobile computers includes a client program stored in a non-transitory memory that receives the electronic data pushed from the second server, displays the electronic data on a display of one or more of the mobile computers, and stores the electronic data to the non-transitory memory of one or more of the mobile computers.

4. The computer network system according to claim 3, wherein the client program of one or more of the mobile computers initiates downloading of software associated with the electronic data from the server via the network.

5. The computer network system according to claim 4, wherein the server transmits the software to the one or more of the mobile computers, and one or more of the mobile computers receives the software and stores the software to the non-transitory memory of the one or more of the mobile computers.

6. The computer network system according to claim 3, wherein the server initiates downloading of software associated with the electronic data to one or more of the mobile computers via the network.

7. The computer network system according to claim 6, wherein the server transmits the software to the one or more of the mobile computers, and one or more of the mobile computers receives the software and stores the software to the non-transitory memory of the one or more of the mobile computers.

8. The computer network system according to claim 3, further comprising a third server connected to the network, wherein the first server controls pushing of electronic data from the third server to one or more of the mobile computer via the network, and
the client program receives the electronic data pushed from the third server, stores the electronic data to the non-transitory memory of one or more of the mobile computers, and displays the electronic data on the display of one or more of the mobile computer.

9. A method for maintaining uniform versions of software on a plurality of mobile computers, the method comprising:
a mobile computer executing a client program stored in a non-transitory memory of the mobile computer;
the mobile computer connecting to a control server via a network to receive information pushed by the control server; and
the mobile computer determining whether the client program is set for automatic download of software related to the information pushed by the control server,
wherein if the client program is set for automatic download and installation of software, then the client program downloads the software to the non-transitory memory of the mobile computer,
wherein if the client program is not set for automatic download of software, then the client program displays the information including data about the software on a display of the mobile computer, and the mobile computer displaying a selection option for downloading the software, and a selection option for installing the software on the display.

10. The method according to claim 9, further comprising:
the control server transmitting the information to the mobile computer; and
the mobile computer receiving the information pushed by the control server.

11. The method according to claim 9, further comprising:
the control server controlling one or more data servers to transmit the information to the mobile computer; and
the mobile computer receiving the information pushed by the one or more data servers.

12. The method according to claim 11,
wherein if the client program is set for automatic download of software associated with the information, then the client program downloads the software associated with the information from the data servers to the non-transitory memory of the mobile computer,
wherein if the client program is not set for automatic download of the software associated with the information, then the client program displays the information including data about the software on a display of the mobile computer, and the mobile computer displays a selection option for downloading the software, and a selection option for installing the software on the display.

13. The method according to claim 9, further comprising:
the mobile computer installing the software when a user initiates the installation of the software via interaction with the client program.
